(19) United States
(12) Patent Application Publication
(10) Pub. No.: US 2013/0000584 A1
(43) Pub. Date: Jan. 3, 2013

(54) LIQUID FUEL COMPOSITIONS

(75) Inventors: Adrian Philip Groves, Hamburg (DE); David Roy Kendall, Chester Cheshire (GB); Clive Richard McDonald, Chester Cheshire (GB); Susan Jane Smith, Chester Cheshire (GB)

(73) Assignee: SHELL INTERNATIONAL RESEARCH MAATSCHAPPIJ B.V.

(21) Appl. No.: 13/519,807

(22) PCT Filed: Dec. 27, 2010
(86) PCT No.: PCT/EP2010/070762

§ 371 Date: Aug. 23, 2012

(30) Foreign Application Priority Data
Dec. 29, 2009 (EP) 09180908.7

(51) Int. Cl. F02B 47/00; C10M 169/04

(52) U.S. Cl. 123/1 A; 508/476

(57) ABSTRACT

The present invention provides a method of improving the performance of the lubricant of an internal combustion engine, said method comprising fuelling an internal combustion engine containing the engine lubricant with a liquid fuel composition comprising:—a base fuel suitable for use in an internal combustion engine; and—one or more poly (hydroxycarboxylic acid) derivative having a terminal amine group having formula (III): [Y—CO[O-A-CO]ₙ—Zₚ]ₘ—X wherein Y is hydrogen or optionally substituted hydrocarbyl group, A is a divalent optionally substituted hydrocarbyl group, n is from 1 to 100, m is 1 or 2, Z is an optionally substituted divalent bridging group, p is from 0 to 10, and X is terminal amine group or a group carrying a terminal amine group, wherein the terminal amine group is selected from —NR¹2, wherein R¹ is independently selected from hydrogen and a C₁-C₆ hydrocarbyl group.

### FIELD OF THE INVENTION

The present invention relates to liquid fuel compositions comprising a major portion of a base fuel suitable for use in an internal combustion engine, in particular liquid fuel compositions comprising a major portion of a base fuel suitable for use in an internal combustion engine and a hyperdispersant.

### BACKGROUND OF THE INVENTION

EP 0 164 817 A2 discloses a surfactant comprising a carboxylic acid ester or amide carrying a terminal strong acid group selected from carboxylic acid, carboxymethyl, sulphate, sulphonate, phosphate and phosphonate, suitable for stabilising dispersions of solids in organic liquids and oil/water emulsions. A preferred species of the surfactant is a poly(hydroxyalkanecarboxylic acid) having the strong acid group attached, either directly or through a linking group, to a terminal hydroxy or carboxylic acid group. The use of such surfactants in fuels is not disclosed therein.

EP 0 233 684 A1 discloses an ester or polyester having (i) a terminal group containing at least two aliphatic carbon-carbon double bonds and (ii) an acidic or basic amino group which is suitable for use as a dispersant for solids in organic liquids. The use of such surfactants in fuels is not disclosed therein.

GB 2 197 312 A discloses oil soluble dispersant additives, wherein said dispersant additives are poly (C₅-C₉ lactone) adducts which have been prepared by first reacting a C₅-C₉ lactone with a polyamine, a polyol or an amino alcohol to form an intermediate adduct, whereafter the intermediate adduct is reacted with an aliphatic hydrocarbyl monocarboxylic or dicarboxylic acylating agent having from about 1 to about 165 total carbon atoms. The use of the dispersant additives in lubricating oils and fuels is also disclosed in GB 2197312 A.

EP 0 802 255 A2 discloses hydroxyl group containing acylated nitrogen compounds which are useful as low chlorine containing additives for lubricating oils and normally liquid fuels and a process for preparing the compounds.

WO 00/34418 A1 discloses the use of poly(hydroxycarboxylic acid)amide or -ester derivatives in fuel compositions as a lubricity additive. It is also disclosed in WO 00/34418 A1 that the use of the poly(hydroxycarboxylic acid)amide or -ester derivatives disclosed therein may also result in attaining one or more of a number of effects such as inlet system cleanliness (intake valves, fuel injectors, carburetors), combustion chamber clealiness (in each case either or both of keep clean and clean-up effects), anti-corrosion (including anti-rust) and reduction or elimination of valve-stick. Benefits in terms of improved fuel economy and improved lubricant performance are not disclosed in WO 00/34418 A1.

EP 1 752 516 A1 discloses the use of polyimine and polyamine derivatives as a dispersant or detergent additive in a hydrocarbon fuel or in an oil of lubricating viscosity. The use in a hydrocarbon fuel is for imparting improved fuel economy, a homogeneous air/fuel mix, nozzle cleanliness, and injector cleanliness. The use in a lubricant is for imparting improved engine cleanliness, improved seal compatibility, improved fuel economy, decreased NOₓ emissions, and decreased particulate emissions. There is no disclosure or suggestion of use in a hydrocarbon fuel for the purpose of improving the performance of a lubricant.

EP 0 304 175 A1 concerns the use of lactone-modified, Mannich base dispersant additives in oleaginous compositions, with their primary utility in lubricating oil compositions. There is also no disclosure or suggestion of use in a hydrocarbon fuel for the purpose of improving the performance of a lubricant in this document.

It has now been found that the use of poly(hydroxycarboxylic acid) derivative having a terminal amine group can surprisingly provide benefits in terms of improved engine lubricant performance when used in a liquid fuel composition to fuel the engine.

### SUMMARY OF THE INVENTION

The present invention provides a method of improving the performance of the lubricant of an internal combustion engine, said method comprising fuelling an internal combustion engine containing the engine lubricant with a liquid fuel composition comprising:
a base fuel suitable for use in an internal combustion engine; and
one or more poly(hydroxycarboxylic acid) derivative having a terminal amine group having formula (III):

[Y—CO[O-A-CO]ₙ—Zₚ]ₘ—X (III)

wherein Y is hydrogen or optionally substituted hydrocarbyl group, A is a divalent optionally substituted hydrocarbyl group, n is from 1 to 100, m is 1 or 2, Z is an optionally substituted divalent bridging group, p is from 0 to 10, and X is terminal amine group or a group carrying a terminal amine group, wherein the terminal amine group is selected from —NR¹₂, wherein R¹ is independently selected from hydrogen and a C₁-C₆ hydrocarbyl group.

The present invention further provides a lubricating composition comprising:
a base oil; and
one or more poly(hydroxycarboxylic acid) derivative having a terminal amine group having formula (III):

[Y—CO[O-A-CO]ₙ—Zₚ]ₘ—X (III)

wherein Y is hydrogen or optionally substituted hydrocarbyl group, A is a divalent optionally substituted hydrocarbyl group, n is from 1 to 100, m is 1 or 2, Z is an optionally substituted divalent bridging group, p is from 0 to 10, and X is terminal amine group or a group carrying a terminal amine group, wherein the terminal amine group is selected from —NR¹₂, wherein R¹ is independently selected from hydrogen and a C₁-C₆ hydrocarbyl group.

### DETAILED DESCRIPTION OF THE INVENTION

The liquid fuel composition used in the present invention comprises a base fuel suitable for use in an internal combustion engine and one or more poly(hydroxycarboxylic acid) derivative having a amine acid group. Typically, the base fuel suitable for use in an internal combustion engine is a gasoline or a diesel fuel, and therefore the liquid fuel composition of the present invention is typically a gasoline composition or a diesel fuel composition.

The poly(hydroxycarboxylic acid) derivative having a terminal amine group used in the present invention may also be referred to as a hyperdispersant.

The one or more poly(hydroxycarboxylic acid) derivative having a terminal amine group in the liquid fuel compositions of the present invention are poly(hydroxycarboxylic acid) derivative having a terminal amine group having formula (III):

[Y—CO[O-A-CO]ₙ—Zₚ]ₘ—X (III)

wherein Y is hydrogen or optionally substituted hydrocarbyl group, A is a divalent optionally substituted hydrocarbyl group, n is from 1 to 100, m is 1 or 2, Z is an optionally substituted divalent bridging group, p is from 0 to 10, and X is terminal amine group or a group carrying a terminal amine group, wherein the terminal amine group is selected from —NR¹₂, wherein R¹ is independently selected from hydrogen and a C₁-C₆ hydrocarbyl group.

In formula (III), A is preferably a divalent straight chain or branched hydrocarbyl group as hereafter described for formulae (I) and (II) below.

That is to say, in formula (III), A is preferably an optionally substituted aromatic, aliphatic or cycloaliphatic straight chain or branched divalent hydrocarbyl group. More preferably, A is an arylene, alkylene or alkenylene group, in particular an arylene, alkylene or alkenylene group containing in the range of from 4 to 25 carbon atoms, more preferably in the range of from 6 to 25 carbon atoms, more preferably in the range of from 8 to 24 carbon atoms, more preferably in the range of from 10 to 22 carbon atoms, and most preferably in the range of from 12 to 20 carbon atoms.

Preferably, in said compound of formula (III), there are at least 4 carbon atoms, more preferably at least 6 carbon atoms, and even more preferably in the range of from 8 to 14 carbon atoms connected directly between the carbonyl group and the oxygen atom derived from the hydroxyl group.

In the compound of formula (III), the optional substituents in the group A are preferably selected from hydroxy, halo or alkoxy groups, especially C₁₋₄ alkoxy groups.

In formula (III) (and formula (I)), n is in the range of from 1 to 100. Preferably, the lower limit of the range for n is 1, more preferably 2, even more preferably 3; preferably the upper limit of the range for n is 100, more preferably 60, more preferably 40, more preferably 20, and even more preferably 10 (i.e. n may be selected from any of the following ranges: from 1 to 100; from 2 to 100; from 3 to 100; from 1 to 60; from 2 to 60; from 3 to 60; from 1 to 40; from 2 to 40; from 3 to 40; from 1 to 20; from 2 to 20; from 3 to 20; from 1 to 10; from 2 to 10; and, from 3 to 10).

In formula (III), Y is preferably an optionally substituted hydrocarbyl group as hereinbefore described for formula (I).

That is to say, the optionally substituted hydrocarbyl group Y in formula (III) is preferably aryl, alkyl or alkenyl containing up to 50 carbon atoms, more preferably in the range of from 7 to 25 carbon atoms. For example, the optionally substituted hydrocarbyl group Y may be conveniently selected from heptyl, octyl, undecyl, lauryl, heptadecyl, heptadenyl, heptadecadienyl, stearyl, oleyl and linoleyl.

Other examples of said optionally substituted hydrocarbyl group Y in formula (III) herein include C₄₋₈ cycloalkyls such as cyclohexyl; polycycloalkyls such as polycyclic terpenyl groups which are derived from naturally occurring acids such as abietic acid; aryls such as phenyl; aralkyls such as benzyl; and polyaryls such as naphthyl, biphenyl, stibenzyl and phenylmethylphenyl.

In the present invention, the optionally substituted hydrocarbyl group Y in formula (III) may contain one or more functional groups such as carbonyl, carboxyl, nitro, hydroxy, halo, alkoxy, amino, preferably tertiary amino (no N—H linkages), oxy, cyano, sulphonyl and sulphoxyl. The majority of the atoms, other than hydrogen, in substituted hydrocarbyl groups are generally carbon, with the heteroatoms (e.g., oxygen, nitrogen and sulphur) generally representing only a minority, about 33% or less, of the total non-hydrogen atoms present.

Those skilled in the art will appreciate that functional groups such as hydroxy, halo, alkoxy, nitro and cyano in a substituted hydrocarbyl group Y will displace one of the hydrogen atoms of the hydrocarbyl, whilst functional groups such as carbonyl, carboxyl, tertiary amino (—N—), oxy, sulphonyl and sulphoxyl in a substituted hydrocarbyl group will displace a —CH— or —CH₂— moiety of the hydrocarbyl.

More preferably, the hydrocarbyl group Y in formula (III) is unsubstituted or substituted by a group selected from hydroxy, halo or alkoxy group, even more preferably C₁₋₄ alkoxy.

Most preferably, the optionally substituted hydrocarbyl group Y in formula (III) is a stearyl group, 12-hydroxystearyl group, an oleyl group or a 12-hydroxyoleyl group, and that derived from naturally occurring oil such as tall oil fatty acid.

In formula (III), Z is an optionally substituted divalent bridging group, preferably of the formula —X^{Z}—B—Y^{Z}_{q}—, wherein X^{Z} is selected from oxygen, sulphur or a group of the formula —NR²—, wherein R² is as described below, B is as described below, Y^{z} is selected from oxygen or a group of the formula —NR²—, wherein R² is as described below, and q is 0 or 1. If q is 1 and both X^{Z} and Y^{z} are groups of the formula —NR¹—, then the two R² groups may form a single hydrocarbyl group linking the two nitrogen atoms.

Conveniently, Z is an optionally substituted divalent bridging group which is attached to the carbonyl group through a nitrogen atom, preferably represented by formula (IV)

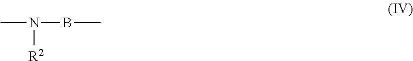

wherein R² is hydrogen or a hydrocarbyl group and B is an optionally substituted alkylene group.

Examples of hydrocarbyl groups that may represent R² include methyl, ethyl, n-propyl, n-butyl and octadecyl.

Examples of optionally substituted alkylene groups that may represent B include ethylene, trimethylene, tetramethylene and hexamethylene.

Examples of preferred Z moieties in formula (III) include —NHCH₂CH₂—, —NHCH₂C(CH₃)₂CH₂— and —NH(CH₂)₃—.

In formula (III), p is selected from 0 to 10, preferably p is selected from 0 to 8, more preferably p is selected from 0 to 6. In one embodiment of the present invention, p is at least 1 (i.e. p is selected from 1 to 10, from 1 to 8, or from 1 to 6), or at least 2 (i.e. p is selected from 2 to 10, from 2 to 8, or from 2 to 6).

In formula (III), X is terminal amine group or a group carrying a terminal amine group, wherein the terminal amine group is selected from —NR¹₂, wherein R¹ is selected from hydrogen and a C₁-C₆ hydrocarbyl group. If X is a group carrying a terminal amine group, then preferably it is a group of the formula —Z¹-X¹, wherein Z¹ is a bifunctional linking compound, such as a compound selected from a polyamine, polyol, hydroxylamine, or a Z group as defined above, and X¹ is a terminal amine group selected from —NR¹₂, wherein R¹ is selected from hydrogen and a C₁-C₆ hydrocarbyl group, if X is a group carrying a terminal acid group, then p in formula (III) is 0 and X is a group of the formula —Z¹-X¹.

The R¹ group in the terminal amine group is preferably independently selected from hydrogen and a C₁-C₄ hydrocarbyl group; more preferably R¹ is independently selected from hydrogen and a C₁-C₄ alkyl group. Examples of suitable C₁-C₄ alkyl groups are methyl, ethyl, n-propyl, i-propyl, n-butyl, i-butyl and t-butyl groups.

Examples of suitable terminal amine groups include —NH₂, —NHCH₃, —NHCH₂CH₃, —NHCH₂CH₂CH₃, —NHCH(CH₃)₂, —NHCH₂CH₂CH₂CH₃, —NHC(CH₃)₃, —N(CH₃)₂, —N(CH₃)CH₂CH₃, —N(CH₃)CH₂CH₂CH₃, —N(CH₂CH₃)₂, —N(CH₂CH₃)CH(CH₃)₂, —N(CH₂CH₃)CH₂CH₂CH₂CH₃, —N(CH₂CH₃)C(CH₃)₃, —N(CH₂CH₃)CH₂CH₃, —N(CH₂CH₃)CH₂CH₂CH₃, —N(CH₂CH₃)CH(CH₃)₂, —N(CH₂CH₃)CH₂CH₂CH₂CH₃, —N(CH₂CH₃)C(CH₃)₃, —N(CH(CH₃)₂)CH₂CH₂CH₃, —N(CH(CH₃))₂, —N(CH(CH₃)₂)CH₂CH₂CH₂CH₃, —N(CH(CH₃)₂)C(CH₃)₃, —N(CH₂CH₂CH₃)CH₂CH₃, —N(CH₂CH₂CH₃)₂, —N(CH₂CH₂CH₃)CH₂CH₂CH₂CH₃, —N(CH₂CH₂CH₃)C(CH₃)₃, —N(CH₂CH₂CH₂CH₃)₂, —N(CH₂CH₂CH₂CH₃)C(CH₃)₃, and —N(C(CH₃)₃)₂.

In one embodiment of the present invention the terminal amine group is —NH₂.

The one or more poly(hydroxycarboxylic acid) derivative having a terminal amine group may be obtained by reaction of:

a poly(hydroxycarboxylic acid) of formula (I)

Y—CO[O-A-CO]ₙ—OH (I)

wherein Y is hydrogen or optionally substituted hydrocarbyl group, A is a divalent optionally substituted hydrocarbyl group and n is from 1 to 100; with:

a compound having a group reactive with the terminal carboxylic acid group of the poly(hydroxycarboxylic acid) of formula (I) and a terminal amine group as defined above;

a precursor of the terminal amine group; or

a bifunctional linking compound which is subsequently reacted with a precursor of the terminal amine group.

As used herein, the term “hydrocarbyl” represents a radical formed by removal of one or more hydrogen atoms from a carbon atom of a hydrocarbon (not necessarily the same carbon atoms in case more hydrogen atoms are removed).

Hydrocarbyl groups may be aromatic, aliphatic, acyclic or cyclic groups. Preferably, hydrocarbyl groups are aryl, cycloalkyl, alkyl or alkenyl, in which case they may be straight-chain or branched-chain groups.

Representative hydrocarbyl groups include phenyl, naphthyl, methyl, ethyl, butyl, pentyl, methylpentyl, hexenyl, dimethylhexyl, octenyl, cyclooctenyl, methylcyclooctenyl, dimethylcyclooctyl, ethylhexyl, octyl, isooctyl, dodecyl, hexadecenyl, eicosyl, hexacosyl, triacontyl and phenylethyl.

In the present invention, the phrase “optionally substituted hydrocarbyl” is used to describe hydrocarbyl groups optionally containing one or more “inert” heteroatom-containing functional groups. By “inert” is meant that the functional groups do not interfere to any substantial degree with the function of the compound.

The optionally substituted hydrocarbyl group Y in formula (I) herein is preferably aryl, alkyl or alkenyl containing up to 50 carbon atoms, more preferably in the range of from 7 to 25 carbon atoms. For example, the optionally substituted hydrocarbyl group Y may be conveniently selected from heptyl, octyl, undecyl, lauryl, heptadecyl, heptadenyl, heptadecadienyl, stearyl, oleyl and linoleyl.

Other examples of said optionally substituted hydrocarbyl group Y in formula (I) herein include C₄₋₈ cycloalkyls such as cyclohexyl; polycycloalkyls such as polycyclic terpenyl groups which are derived from naturally occurring acids such as abietic acid; aryls such as phenyl; aralkyls such as benzyl; and polyaryls such as naphthyl, biphenyl, stibenzyl and phenylmethylphenyl.

In the present invention, the optionally substituted hydrocarbyl group Y may contain one or more functional groups such as carbonyl, carboxyl, nitro, hydroxy, halo, alkoxy, tertiary amino (no N—H linkages), oxy, cyano, sulphonyl and sulphoxyl. The majority of the atoms, other than hydrogen, in substituted hydrocarbyl groups are generally carbon, with the heteroatoms (e.g., oxygen, nitrogen and sulphur) generally representing only a minority, about 33% or less, of the total non-hydrogen atoms present.

Those skilled in the art will appreciate that functional groups such as hydroxy, halo, alkoxy, nitro and cyano in a substituted hydrocarbyl group Y will displace one of the hydrogen atoms of the hydrocarbyl, whilst functional groups such as carbonyl, carboxyl, tertiary amino (—N—), oxy, sulphonyl and sulphoxyl in a substituted hydrocarbyl group will displace a —CH— or —CH₂— moiety of the hydrocarbyl.

The hydrocarbyl group Y in formula (I) is more preferably unsubstituted or substituted by a group selected from hydroxy, halo or alkoxy group, even more preferably C₁₋₄ alkoxy.

Most preferably, the optionally substituted hydrocarbyl group Y in formula (I) is a stearyl group, 12-hydroxystearyl group, an oleyl group, a 12-hydroxyoleyl group or a group derived from naturally occurring oil such as tall oil fatty acid.

The preparation of poly(hydroxycarboxylic acid) and its derivatives is known and is described in the art, for example in EP 0 164 817.

The poly(hydroxycarboxylic acid)s of formula (I) may be made by the interesterification of one or more hydroxycarboxylic acids of formula (II)

HO-A-COOH (II)

wherein A is a divalent optionally substituted hydrocarbyl group, optionally in the presence of a catalyst according to well known methods. Such methods are described, for example, in U.S. Pat. No. 3,996,059, GB 1 373 660 and GB 1 342 746.

The chain terminator in said interesterification may be a non-hydroxycarboxylic acid.

The hydroxyl group in the hydroxycarboxylic acid and the carboxylic acid group in the hydroxycarboxylic acid or the non-hydroxycarboxylic acid may be primary, secondary or tertiary in character.

The interesterification of the hydroxycarboxylic acid and the non-hydroxycarboxylic acid chain terminator may be effected by heating the starting materials, optionally in a suitable hydrocarbon solvent such as toluene or xylene, and azeotroping off the formed water. The reaction may be carried out at a temperature up to −250° C., conveniently at the reflux temperature of the solvent.

Where the hydroxyl group in the hydroxycarboxylic acid is secondary or tertiary, the temperature employed should not be so high as to lead to dehydration of the acid molecule.

Catalysts for the interesterification, such as p-toluenesulphonic acid, zinc acetate, zirconium naphthenate or tetrabutyl titanate, may be included, with the objective of either increasing the rate of reaction at a given temperature or of reducing the temperature required for a given rate of reaction.

In the compounds of formulae (I) and (II), A is preferably an optionally substituted aromatic, aliphatic or cycloaliphatic straight chain or branched divalent hydrocarbyl group. Preferably, A is an arylene, alkylene or alkenylene group, in particular an arylene, alkylene or alkenylene group containing in the range of from 4 to 25 carbon atoms, more preferably in the range of from 6 to 25 carbon atoms, more preferably in the range of from 8 to 24 carbon atoms, more preferably in the range of from 10 to 22 carbon atoms, and most preferably in the range of from 12 to 20 carbon atoms.

Preferably, in said compounds of formulae (I) and (II), there are at least 4 carbon atoms, more preferably at least 6 carbon atoms, and even more preferably in the range of from 8 to 14 carbon atoms connected directly between the carbonyl group and the oxygen atom derived from the hydroxyl group.

In the compounds of formulae (I) and (II), the optional substituents in the group A are preferably selected from hydroxy, halo or alkoxy groups, more preferably C₁₋₄ alkoxy groups.

The hydroxyl group in the hydroxycarboxylic acids of formula (II) is preferably a secondary hydroxyl group.

Examples of suitable hydroxycarboxylic acids are 9-hydroxystearic acid, 10-hydroxystearic acid, 12-hydroxystearic acid, 12-hydroxy-9-oleic acid (ricinoleic acid), 6-hydroxycaproic acid, preferably 12-hydroxystearic acid. Commercial 12-hydroxystearic acid (hydrogenated castor oil fatty acid) normally contains up to 15% wt of stearic acid and other non-hydroxycarboxylic acids as impurities and can conveniently be used without further admixture to produce a polymer of molecular weight about 1000-2000.

Where the non-hydroxycarboxylic acid is introduced separately to the reaction, the proportion which is required in order to produce a polymer or oligomer of a given molecular weight can be determined either by simple experiment or by calculation by the person skilled in the art.

The group (—O-A-CO—) in the compounds of formulae (I) and (II) is preferably a 12-oxystearyl group, 12-oxyoleyl group or a 6-oxycaproyl group.

Preferred poly(hydroxycarboxylic acid)s of formula (I) for reaction with amine include poly(hydroxystearic acid) and poly(hydroxyoleic acid).

Suitable compounds having a group reactive with the terminal carboxylic acid group of the poly(hydroxycarboxylic acid) of formula (I) and a terminal amine group, include unsubstituted and substituted amines, diamines, and polyamines, examples of substituted amines are mono-, di- and tri-alkylamines, alkyleneamines, and alpha-amino- or alpha-hydroxy-alkane amines, most suitably ethylenediamine, diethylenetriamine, triethylenetetramine, tetraethylenepennamine and pentaethylenehexamine, most preferably tetraethylenepentamine; and, suitable bifunctional linking compounds, which can form a linking group between the polyester and the terminal amine group, are polyamines, polyols, hydroxyamines and Z groups as described above.

The reaction of a compound having a group reactive with the terminal carboxylic acid group of the poly(hydroxycarboxylic acid) of formula (I) and a terminal amine group;

a precursor of the terminal amine group; or

a bifunctional linking compound which is subsequently reacted with a precursor of the terminal amine group, with a poly(hydroxycarboxylic acid) of formula (I) is known and is described in the art, for example in EP 0 164 817.

The poly(hydroxycarboxylic acid) derivatives having a terminal amine group that are preferred in the present invention are those which each have a TBN (total base number) value of at least 100 mg.KOH/g, more preferably at least 150 mg.KOH/g, even more preferably at least 175 mg.KOH/g and most preferably at least 200 mg.KOH/g, as measured by ASTM D 4739. The TBN may be at most 300 mg.KOH/g, preferably at most 250 mg.KOH/g.

The poly(hydroxycarboxylic acid) derivatives having a terminal amine group that are preferred in the present invention are those which each have an acid value of less than 20 mg.KOH/g, more preferably less than 15 mg.KOH/g, even more preferably less than 10 mg.KOH/g and most preferably less than 7 mg.KOH/g. The TAN may be at least 0 mg.KOH/g.

In the liquid fuel compositions of the present invention, if the base fuel used is a gasoline, then the gasoline may be any gasoline suitable for use in an internal combustion engine of the spark-ignition (petrol) type known in the art. The gasoline used as the base fuel in the liquid fuel composition of the present invention may conveniently also be referred to as ‘base gasoline’.

Gasolines typically comprise mixtures of hydrocarbons boiling in the range from 25 to 230° C. (EN-ISO 3405), the optimal ranges and distillation curves typically varying according to climate and season of the year. The hydrocarbons in a gasoline may be derived by any means known in the art, conveniently the hydrocarbons may be derived in any known manner from straight-run gasoline, synthetically-produced aromatic hydrocarbon mixtures, thermally or catalytically cracked hydrocarbons, hydro-cracked petroleum fractions, catalytically reformed hydrocarbons or mixtures of these.

The specific distillation curve, hydrocarbon composition, research octane number (RON) and motor octane number (MON) of the gasoline are not critical.

Conveniently, the research octane number (RON) of the gasoline may be at least 80, for instance in the range of from 80 to 110, preferably the RON of the gasoline will be at least 90, for instance in the range of from 90 to 110, more preferably the RON of the gasoline will be at least 91, for instance in the range of from 91 to 105, even more preferably the RON of the gasoline will be at least 92, for instance in the range of from 92 to 103, even more preferably the RON of the gasoline will be at least 93, for instance in the range of from 93 to 102, and most preferably the RON of the gasoline will be at least 94, for instance in the range of from 94 to 100 (EN 25164); the motor octane number (MON) of the gasoline may conveniently be at least 70, for instance in the range of from 70 to 110, preferably the MON of the gasoline will be at least 75, for instance in the range of from 75 to 105, more preferably the MON of the gasoline will be at least 80, for instance in the range of from 80 to 100, most preferably the MON of the gasoline will be at least 82, for instance in the range of from 82 to 95 (EN 25163).

Typically, gasolines comprise components selected from one or more of the following groups; saturated hydrocarbons, olefinic hydrocarbons, aromatic hydrocarbons, and oxygenated hydrocarbons. Conveniently, the gasoline may comprise a mixture of saturated hydrocarbons, olefinic hydrocarbons, aromatic hydrocarbons, and, optionally, oxygenated hydrocarbons.

Typically, the olefinic hydrocarbon content of the gasoline is in the range of from 0 to 40 percent by volume based on the gasoline (ASTM D1319); preferably, the olefinic hydrocarbon content of the gasoline is in the range of from 0 to 30 percent by volume based on the gasoline, more preferably, the olefinic hydrocarbon content of the gasoline is in the range of from 0 to 20 percent by volume based on the gasoline.

Typically, the aromatic hydrocarbon content of the gasoline is in the range of from 0 to 70 percent by volume based on the gasoline (ASTM D1319), for instance the aromatic hydrocarbon content of the gasoline is in the range of from 10 to 60 percent by volume based on the gasoline; preferably, the aromatic hydrocarbon content of the gasoline is in the range of from 0 to 50 percent by volume based on the gasoline, for instance the aromatic hydrocarbon content of the gasoline is in the range of from 10 to 50 percent by volume based on the gasoline.

The benzene content of the gasoline is at most 10 percent by volume, more preferably at most 5 percent by volume, especially at most 1 percent by volume based on the gasoline.

The gasoline preferably has a low or ultra low sulphur content, for instance at most 1000 ppmw (parts per million by weight), preferably no more than 500 ppmw, more preferably no more than 100, even more preferably no more than 50 and most preferably no more than even 10 ppmw.

The gasoline also preferably has a low total lead content, such as at most 0.005 g/l, most preferably being lead free—having no lead compounds added thereto (i.e. unleaded).

When the gasoline comprises oxygenated hydrocarbons, at least a portion of non-oxygenated hydrocarbons will be substituted for oxygenated hydrocarbons. The oxygen content of the gasoline may be up to 35 percent by weight (EN 1601) (e.g. ethanol per se) based on the gasoline. For example, the oxygen content of the gasoline may be up to 25 percent by weight, preferably up to 10 percent by weight. Conveniently, the oxygenate concentration will have a minimum concentration selected from any one of 0, 0.2, 0.4, 0.6, 0.8, 1.0, and 1.2 percent by weight, and a maximum concentration selected from any one of 5, 4.5, 4.0, 3.5, 3.0, and 2.7 percent by weight.

Examples of oxygenated hydrocarbons that may be incorporated into the gasoline include alcohols, ethers, esters, ketones, aldehydes, carboxylic acids and their derivatives, and oxygen containing heterocyclic compounds. Preferably, the oxygenated hydrocarbons that may be incorporated into the gasoline are selected from alcohols (such as methanol, ethanol, propanol, 2-propanol, butanol, tert-butanol, 2-butanol and iso-butanol), ethers (preferably ethers containing 5 or more carbon atoms per molecule, e.g., methyl tert-butyl ether) and esters (preferably esters containing 5 or more carbon atoms per molecule); a particularly preferred oxygenated hydrocarbon is ethanol.

When oxygenated hydrocarbons are present in the gasoline, the amount of oxygenated hydrocarbons in the gasoline may vary over a wide range. For example, gasolines comprising a major proportion of oxygenated hydrocarbons are currently commercially available in countries such as Brazil and U.S.A., e.g. ethanol per se and E85, as well as gasolines comprising a minor proportion of oxygenated hydrocarbons, e.g. E10 and E5. Therefore, the gasoline may contain up to 100 percent by volume oxygenated hydrocarbons. Preferably, the amount of oxygenated hydrocarbons present in the gasoline is selected from one of the following amounts: up to 85 percent by volume; up to 65 percent by volume; up to 30 percent by volume; up to 20 percent by volume; up to 15 percent by volume; and, up to 10 percent by volume, depending upon the desired final formulation of the gasoline. Conveniently, the gasoline may contain at least 0.5, 1.0 or 2.0 percent by volume oxygenated hydrocarbons.

Examples of suitable gasolines include gasolines which have an olefinic hydrocarbon content of from 0 to 20 percent by volume (ASTM D1319), an oxygen content of from 0 to 5 percent by weight (EN 1601), an aromatic hydrocarbon content of from 0 to 50 percent by volume (ASTM D1319) and a benzene content of at most 1 percent by volume.

Whilst not critical to the present invention, the base gasoline or the gasoline composition of the present invention may conveniently additionally include one or more fuel additive. The concentration and nature of the fuel additive(s) that may be included in the base gasoline or the gasoline composition of the present invention is not critical. Non-limiting examples of suitable types of fuel additives that can be included in the base gasoline or the gasoline composition of the present invention include anti-oxidants, corrosion inhibitors, detergents, dehazers, antiknock additives, metal deactivators, valve-seat recession protectant compounds, dyes, friction modifiers, carrier fluids, diluents and markers. Examples of suitable such additives are described generally in U.S. Pat. No. 5,855,629.

Conveniently, the fuel additives can be blended with one or more diluents or carrier fluids, to form an additive concentrate, the additive concentrate can then be admixed with the base gasoline or the gasoline composition of the present invention.

The (active matter) concentration of any additives present in the base gasoline or the gasoline composition of the present invention is preferably up to 1 percent by weight, more preferably in the range from 5 to 1000 ppmw, advantageously in the range of from 75 to 300 ppmw, such as from 95 to 150 ppmw.

In the liquid fuel compositions of the present invention, if the base fuel used is a diesel fuel, then the diesel fuel used as the base fuel in the present invention includes diesel fuels for use in automotive compression ignition engines, as well as in other types of engine such as for example marine, railroad and stationary engines. The diesel fuel used as the base fuel in the liquid fuel composition of the present invention may conveniently also be referred to as ‘diesel base fuel’.

The diesel base fuel may itself comprise a mixture of two or more different diesel fuel components, and/or be additivated as described below.

Such diesel fuels will contain one or more base fuels which may typically comprise liquid hydrocarbon middle distillate gas oil(s), for instance petroleum derived gas oils. Such fuels will typically have boiling points within the usual diesel range of 150 to 400° C., depending on grade and use. They will typically have a density from 750 to 1000 kg/m³, preferably from 780 to 860 kg/m³, at 15° C. (e.g. ASTM D4502 or IP 365) and a cetane number (ASTM D613) of from 35 to 120, more preferably from 40 to 85. They will typically have an initial boiling point in the range 150 to 230° C. and a final boiling point in the range 290 to 400° C. Their kinematic viscosity at 40° C. (ASTM D445) might suitably be from 1.2 to 4.5 mm²/s.

An example of a petroleum derived gas oil is a Swedish Class 1 base fuel, which will have a density from 800 to 820 kg/m³ at 15° C. (SS-EN ISO 3675, SS-EN ISO 12185), a T95 of 320° C. or less (SS-EN ISO 3405) and a kinematic viscosity at 40° C. (SS-EN ISO 3104) from 1.4 to 4.0 mm²/s, as defined by the Swedish national specification EC1.

Optionally, non-mineral oil based fuels, such as biofuels or Fischer-Tropsch derived fuels, may also form or be present in the diesel fuel. Such Fischer-Tropsch fuels may for example be derived from natural gas, natural gas liquids, petroleum or shale oil, petroleum or shale oil processing residues, coal or biomass.

The amount of Fischer-Tropsch derived fuel used in the diesel fuel may be from 0% to 100% v of the overall diesel fuel, preferably from 5% to 100% v, more preferably from 5% to 75% v. It may be desirable for such a diesel fuel to contain 10% v or greater, more preferably 20% v or greater, still more preferably 30% v or greater, of the Fischer-Tropsch derived fuel. It is particularly preferred for such diesel fuels to contain 30 to 75% v, and particularly 30 or 70% v, of the Fischer-Tropsch derived fuel. The balance of the diesel fuel is made up of one or more other diesel fuel components.

Such a Fischer-Tropsch derived fuel component is any fraction of the middle distillate fuel range, which can be isolated from the (optionally hydrocracked) Fischer-Tropsch synthesis product. Typical fractions will boil in the naphtha, kerosene or gas oil range. Preferably, a Fischer-Tropsch product boiling in the kerosene or gas oil range is used because these products are easier to handle in for example domestic environments. Such products will suitably comprise a fraction larger than 90 wt % which boils between 160 and 400° C., preferably to about 370° C. Examples of Fischer-Tropsch derived kerosene and gas oils are described in EP-A-0583836, WO-A-97/14768, WO-A-97/14769, WO-A-00/11116, WO-A-00/11117, WO-A-01/83406, WO-A-01/83648, WO-A-01/83647, WO-A-01/83641, WO-A-00/20535, WO-A-00/20534, EP-A-1101813, U.S. Pat. No. 5,766,274, U.S. Pat. No. 5,378,348, U.S. Pat. No. 5,888,376 and U.S. Pat. No. 6,204,426.

The Fischer-Tropsch product will suitably contain more than 80 wt % and more suitably more than 95 wt % iso and normal paraffins and less than 1 wt % aromatics, the balance being naphthenics compounds. The content of sulphur and nitrogen will be very low and normally below the detection limits for such compounds. For this reason the sulphur content of a diesel fuel composition containing a Fischer-Tropsch product may be very low.

The diesel fuel composition preferably contains no more than 5000 ppmw sulphur, more preferably no more than 500 ppmw, or no more than 350 ppmw, or no more than 150 ppmw, or no more than 100 ppmw, or no more than 70 ppmw, or no more than 50 ppmw, or no more than 30 ppmw, or no more than 20 ppmw, or most preferably no more than 15 ppmw sulphur.

The diesel base fuel may itself be additivated (additive-containing) or unadditivated (additive-free). If additivated, e.g. at the refinery, it will contain minor amounts of one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents.

Detergent-containing diesel fuel additives are known and commercially available. Such additives may be added to diesel fuels at levels intended to reduce, remove, or slow the build up of engine deposits.

Examples of detergents suitable for use in diesel fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557516 and WO-A-98/42808. Particularly preferred are polyolefin substituted succinimides such as polyisobutylene succinimides.

The diesel fuel additive mixture may contain other components in addition to the detergent. Examples are lubricity enhancers; dehazers, e.g. alkoxylated phenol formaldehyde polymers; anti-foaming agents (e.g. polyether-modified polysiloxanes); ignition improvers (cetane improvers) (e.g. 2-ethylhexyl nitrate (EHN), cyclohexyl nitrate, di-tert-butyl peroxide and those disclosed in U.S. Pat. No. 4,208,190 at column 2, line 27 to column 3, line 21); anti-rust agents (e.g. a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); metal deactivators; combustion improvers; static dissipator additives; cold flow improvers; and wax anti-settling agents.

The diesel fuel additive mixture may contain a lubricity enhancer, especially when the diesel fuel composition has a low (e.g. 500 ppmw or less) sulphur content. In the additivated diesel fuel composition, the lubricity enhancer is conveniently present at a concentration of less than 1000 ppmw, preferably between 50 and 1000 ppmw, more preferably between 70 and 1000 ppmw. Suitable commercially available lubricity enhancers include ester- and acid-based additives. Other lubricity enhancers are described in the patent literature, in particular in connection with their use in low sulphur content diesel fuels, for example in:
the paper by Danping Wei and H. A. Spikes, “The Lubricity of Diesel Fuels”, Wear, III (1986) 217-235;
WO-A-95/33805—cold flow improvers to enhance lubricity of low sulphur fuels;
WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;
U.S. Pat. No. 5,490,864—certain dithiophosphoric diester-dialcohols as anti-wear lubricity additives for low sulphur diesel fuels; and
WO-A-98/01516—certain alkyl aromatic compounds having at least one carboxyl group attached to their aromatic nuclei, to confer anti-wear lubricity effects particularly in low sulphur diesel fuels.

It may also be preferred for the diesel fuel composition to contain an anti-foaming agent, more preferably in combination with an anti-rust agent and/or a corrosion inhibitor and/or a lubricity enhancing additive.

Unless otherwise stated, the (active matter) concentration of each such additive component in the additivated diesel fuel composition is preferably up to 10000 ppmw, more preferably in the range from 0.1 to 1000 ppmw, advantageously from 0.1 to 300 ppmw, such as from 0.1 to 150 ppmw.

The (active matter) concentration of any dehazer in the diesel fuel composition will preferably be in the range from 0.1 to 20 ppmw, more preferably from 1 to 15 ppmw, still more preferably from 1 to 10 ppmw, advantageously from 1 to 5 ppmw. The (active matter) concentration of any ignition improver present will preferably be 2600 ppmw or less, more preferably 2000 ppmw or less, conveniently from 300 to 1500 ppmw. The (active matter) concentration of any detergent in the diesel fuel composition will preferably be in the range from 5 to 1500 ppmw, more preferably from 10 to 750 ppmw, most preferably from 20 to 500 ppmw.

In the case of a diesel fuel composition, for example, the fuel additive mixture will typically contain a detergent, optionally together with other components as described above, and a diesel fuel-compatible diluent, which may be a mineral oil, a solvent such as those sold by Shell companies under the trade mark “SHELLSOL”, a polar solvent such as an ester and, in particular, an alcohol, e.g. hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available.

The total content of the additives in the diesel fuel composition may be suitably between 0 and 10000 ppmw and preferably below 5000 ppmw.

In the above, amounts (concentrations, % vol, ppmw, % wt) of components are of active matter, i.e. exclusive of volatile solvents/diluent materials.

The liquid fuel composition of the present invention is produced by admixing the one or more poly(hydroxycarboxylic acid) derivative having a terminal amine group with a base fuel suitable for use in an internal combustion engine. If the base fuel to which the one or more poly(hydroxycarboxylic acid) derivative having a terminal amine group is admixed is a gasoline, then the liquid fuel composition produced is a gasoline composition; likewise, if the base fuel to which the one or more poly(hydroxycarboxylic acid) derivative having a terminal amine group is admixed is a diesel fuel, then the liquid fuel composition produced is a diesel fuel composition.

Preferably, the amount of the one or more poly(hydroxycarboxylic acid) derivative having a terminal amine group present in the liquid fuel composition of the present invention is at least 1 ppmw (part per million by weight), based on the overall weight of the liquid fuel composition. More preferably, the amount of the one or more poly(hydroxycarboxylic acid) derivative having a terminal amine group present in the liquid fuel composition of the present invention additionally accords with one or more of the parameters (i) to (xx) listed below:

(i) at least 10 ppmw

(ii) at least 20 ppmw

(iii) at least 30 ppmw

(iv) at least 40 ppmw

(v) at least 50 ppmw

(vi) at least 60 ppmw

(vii) at least 70 ppmw

(viii) at least 80 ppmw

(ix) at least 90 ppmw

(x) at least 100 ppmw

(xi) at most 20% wt.

(xii) at most 18% wt.

(xiii) at most 16% wt.

(xiv) at most 14% wt.

(xv) at most 12% wt.

(xvi) at most 10% wt.

(xvii) at most 8% wt.

(xviii) at most 6% wt.

(xix) at most 4% wt.

(xx) at most 2% wt.

Conveniently, the amount of the one or more poly(hydroxycarboxylic acid) derivative having a terminal amine group present in the liquid fuel composition of the present invention may also be at least 20 ppmw, at least 50 ppmw, at least 70 ppmw, at least 100 ppmw, at least 150 ppmw or at least 200 ppmw. At most, the amount of the derivative may be 100 ppmw, at most 150 ppmw, at most 200 ppmw, at most 300 ppmw, at most 400 ppmw, at most 500 ppmw, or even at most 1000 ppmw. Very suitably, the derivative may be present in an amount in the range of from 50 ppmw to 150 ppmw, for example from 70 ppmw to 120 ppmw.

It has been found that the use of the one or more poly(hydroxycarboxylic acid) derivative having a terminal amine group in liquid fuel compositions can also provide benefits in terms improved fuel economy of an internal combustion engine being fuelled by the liquid fuel composition of the present invention, in particular when the liquid fuel composition of the present invention is a gasoline composition, relative to the internal combustion engine being fuelled by the liquid base fuel.

The present invention therefore provides a method of improving the fuel economy performance of a liquid base fuel suitable for use in an internal combustion engine, comprising admixing one or more poly(hydroxycarboxylic acid) derivative having a terminal amine group with a major portion of the liquid base fuel suitable for use in an internal combustion engine.

Additionally, the use of the one or more poly(hydroxycarboxylic acid) derivative having a terminal amine group in liquid fuel compositions can surprisingly also provide benefits in terms improving the lubricant performance of an internal combustion engine being fuelled by the liquid fuel composition of the present invention relative to the internal combustion engine being fuelled by the liquid base fuel.

In particular, the improvement in the lubricant performance of the internal combustion engine fuelled by a liquid fuel composition according to the present invention can be observed by a reduction in the levels of sludge and varnish on specific engine parts, such as sludge on rocker arm covers, cam baffles, timing chain covers, oil pans, oil pan baffles, and valve decks, and varnish on piston skirts and cam baffles.

In particular, the use of the one or more poly(hydroxycarboxylic acid) derivative having a terminal amine group in a gasoline compositions can provide benefits in terms of inhibiting specific sludge and varnish deposit formation, as measured by ASTM D 6593-07, of an internal combustion engine being fuelled by the gasoline composition of the present invention relative to the internal combustion engine being fuelled by the gasoline base fuel.

Therefore, the present invention also provides a method of improving the performance of the lubricant of an internal combustion engine, said method comprising fuelling an internal combustion engine containing the engine lubricant with a liquid fuel composition according to the present invention.

It has additionally been observed that the use of the one or more poly(hydroxycarboxylic acid) derivative having a terminal amine group in the liquid fuel compositions can provide significant benefits in terms of improved lubricity of the liquid fuel composition, in particular when the liquid fuel composition is gasoline, relative to the liquid base fuel.

By the term “improved/improving lubricity” used herein, it is meant that the wear scar produced using a high frequency reciprocating rig (HFRR) is reduced.

It has further been observed that the use of the one or more poly(hydroxycarboxylic acid) derivative having a terminal amine group in liquid fuel compositions can also provide benefits in terms of engine cleanliness, in particular in terms of improved inlet valve deposit keep clean and/or injector nozzle keep clean performance, of an internal combustion engine being fuelled by the liquid fuel composition of the present invention relative to the internal combustion engine being fuelled by the liquid base fuel.

By the term “improved/improving inlet valve deposit keep clean performance”, it is meant that the weight of deposit formed on the inlet valve of the engine is reduced relative to the base fuel not containing the one or more poly(hydroxycarboxylic acid) derivative having a terminal amine group.

By the term “improved/improving injector nozzle keep clean performance”, it is meant that the amount of deposit formed on the injector nozzle of the engine is reduced as measured by the loss of engine torque.

The poly(hydroxycarboxylic acid) derivatives having a terminal amine group described above may also be conveniently used in lubricating compositions, in particular in automotive engine lubricating oil compositions. WO 2007/128740, which is incorporated herein by reference, discloses suitable lubricating base oils and additives to which the poly(hydroxycarboxylic acid) derivatives having a terminal amine group described above may be admixed.

Therefore, the present invention further provides a lubricating composition comprising:
a base oil; and
poly(hydroxycarboxylic acid) derivatives having a terminal amine group as described above.

Typically, the poly(hydroxycarboxylic acid) derivatives having a terminal amine group is present in the lubricating composition of the present invention in an amount in the range of from 0.1 to 10.0 wt. %, more preferably in an amount in the range of from 0.1 to 5.0 wt. %, based on the total weight of the lubricating composition. According to an especially preferred embodiment, the composition comprises less than 5.0 wt. %, preferably less than 2.0 wt. % of the poly(hydroxycarboxylic acid) derivatives having a terminal amine group, based on the total weight of the lubricant composition.

Typically the lubricating composition has a relatively low phosphorus content such as below 0.12 wt. % (according to ASTM D 5185). Preferably, the composition has a phosphorus content of less than 0.08 wt. %. Preferably, the composition has a phosphorus content of above 0.06 wt. %.

Also, it is preferred that the composition has a sulphur content of less than 0.6 wt. % (according to ASTM D 5185).

Further it is preferred that the composition has a chlorine content of less than 200 ppm (according to ASTM D 808).

According to an especially preferred embodiment, the composition has an ash content of below 2.0 wt. % (according to ASTM D 874).

According to an especially preferred embodiment of the present invention, the composition comprises a zinc dialkyl dithiophosphate (ZDDP) compound. Typically, if present, the ZDDP compound is present in an amount of 0.01-1.5 wt. %, preferably 0.4-1.0 wt. %. The ZDDP compound may have been made from primary, secondary, tertiary alcohols or mixtures thereof, preferably containing less than 12 carbon atoms. Preferably, the ZDDP compound has been made from secondary alcohols containing 3 to 8 carbon atoms.

There are no particular limitations regarding the base oil used in the lubricating composition, and various conventional mineral oils, synthetic oils as well as naturally derived esters such as vegetable oils may be conveniently used.

The base oil used may conveniently comprise mixtures of one or more mineral oils and/or one or more synthetic oils; thus, the term “base oil” may refer to a mixture containing more than one base oil. Mineral oils include liquid petroleum oils and solvent-treated or acid-treated mineral lubricating oil of the paraffinic, naphthenic, or mixed paraffinic/naphthenic type which may be further refined by hydrofinishing processes and/or dewaxing.

Suitable base oils for use in the lubricating oil composition are Group I-III mineral base oils, Group IV poly-alpha olefins (PAOs), Group II-III Fischer-Tropsch derived base oils and mixtures thereof.

By “Group I”, “Group II”, “Group III” and “Group IV” base oils are meant lubricating oil base oils according to the definitions of American Petroleum Institute (API) for categories I-IV. These API categories are defined in API Publication 1509, 16th Edition, Appendix E, April 2007.

Fischer-Tropsch derived base oils are known in the art. By the term “Fischer-Tropsch derived” is meant that a base oil is, or is derived from, a synthesis product of a Fischer-Tropsch process. A Fischer-Tropsch derived base oil may also be referred to as a GTL (Gas-To-Liquids) base oil. Suitable Fischer-Tropsch derived base oils that may be conveniently used as the base oil in the lubricating composition are those as for example disclosed in EP 0 776 959, EP 0 668 342, WO 97/21788, WO 00/15736, WO 00/14188, WO 00/14187, WO 00/14183, WO 00/14179, WO 00/08115, WO 99/41332, EP 1 029 029, WO 01/18156 and WO 01/57166.

Synthetic oils include hydrocarbon oils such as olefin oligomers (including polyalphaolefin base oils; PAOs), dibasic acid esters, polyol esters, polyalkylene glycols (PAGs), alkyl naphthalenes and dewaxed waxy isomerates. Synthetic hydrocarbon base oils sold by the Shell Group under the designation “Shell XHVI” (trade mark) may be conveniently used.

Poly-alpha olefin base oils (PAOs) and their manufacture are well known in the art. Preferred poly-alpha olefin base oils that may be used in the lubricating compositions may be derived from linear C₂ to C₃₂, preferably C₆ to C₁₆, alpha olefins. Particularly preferred feedstocks for said poly-alpha olefins are 1-octene, 1-decene, 1-dodecene and 1-tetradecene.

The total amount of base oil incorporated in the lubricating composition is preferably present in an amount in the range of from 60 to 99 wt. %, more preferably in an amount in the range of from 65 to 98 wt. % and most preferably in an amount in the range of from 70 to 95 wt. %, with respect to the total weight of the lubricating composition.

Preferably, the finished lubricating composition has a kinematic viscosity in the range of from 2 to 80 mm²/s at 100° C., more preferably in the range of from 3 to 70 mm²/s, most preferably in the range of from 4 to 50 mm²/s.

The lubricating composition may further comprise additional additives such as anti-wear additives, anti-oxidants, dispersants, detergents, friction modifiers, viscosity index improvers, pour point depressants, corrosion inhibitors, defoaming agents and seal fix or seal compatibility agents.

As the person skilled in the art is familiar with the above and other additives, these are not further discussed here in detail. Specific examples of such additives are described in for example Kirk-Othmer Encyclopedia of Chemical Technology, third edition, volume 14, pages 477-526.

Preferably the detergent, if present, is selected from phenate- and sulphonate-type detergents; accordingly.

The lubricating compositions may be conveniently prepared by admixing the poly(hydroxycarboxylic acid) derivatives having a terminal amine group described above, and, optionally, any further additives that are usually present in lubricating compositions, for example as herein before described, with mineral and/or synthetic base oil.

The use of poly(hydroxycarboxylic acid) derivatives having a terminal amine group described above, in lubricating compositions can provide benefits in terms of improved lubricity of the lubricating composition.

Additionally, the use of poly(hydroxycarboxylic acid) derivatives having a terminal amine group described above, in lubricating compostions can provide benefits in terms of inhibiting specific sludge and varnish deposit formation, as measured by ASTM D 6593-07.

Additionally, the use of poly(hydroxycarboxylic acid) derivatives having a terminal amine group described above, in lubricating compositions can provide benefits in terms of improving the fuel economy of an internal combustion engine lubricated by the lubricating composition.

The present invention will be further understood from the following examples. Unless otherwise stated, all amounts and concentrations disclosed in the examples are based on weight of the fully formulated fuel composition.

### EXAMPLES

In the following examples, a commercially available hyperdispersant, CH-6, which is available from Shanghai Sanzheng Polymer Material Co Ltd (China), was used. The CH-6 hyperdispersant had a measured sulphur content of less than 0.001% wt, a measured nitrogen content of 6.76% wt., and a general chemical structure of the type given in FIG. 1 below:

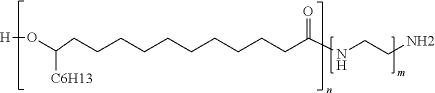

FIG. 1: Chemical structure of CH-6

The measured TAN value of CH-6 was 5.5 mg.KOH/g, as measured by ASTM D974. The measured TBN was 202.9 mg.KOH/g, as measured by ASTM D4739.

### Engine Lubricant Performance

The performance of the crankcase lubricant of an engine fuelled using a liquid fuel composition according to the present invention and containing the CH-6 poly(hydroxycarboxylic acid) derivative was assessed using the Sequence VG test, ASTM D 6593-07 in comparison to the use of the base fuel without the CH-6 hyperdispersant.

The base fuel used was an ASTM V G base fuel and the lubricant used was a SL/CF grade lubricant.

The results of the Sequence V G test are provided in Table 1 below. The “merit” rating used in the results is on a scale of 0 to 10, with 10 representing the rating of the condition of the component when new, and a single number increase in the “merit” rating represents a reduction in the sludge or varnish by half. Thus the closer the rating is to 10, the better the performance.

TABLE 1
Sequence V G test results

| | | Final Original Unit Results | | | |
|---|---|---|---|---|---|
| | | Average | Rocker | Average | Average |
| | | Engine | Cover | Engine | Piston |
| | | Sludge | Sludge | Varnish | Skirt |
| Example | Fuel | (merit) | (merit) | (merit) | Varnish |
| 1 | ASTM V G base | 9.55 | 9.71 | 9.90 | 9.94 |
| | fuel + 500 ppmw | | | | |
| | CH-6 | | | | |
| A* | ASTM V G base | 7.02 | 7.49 | 9.33 | 8.41 |
| | fuel (no | | | | |
| | additive) | | | | |

*Comparative

As can clearly be seen from the results given in Table 1 above, the use of poly(hydroxycarboxylic acid) derivative in the gasoline composition results in a significant improvement in the performance of the lubricant in terms of inhibition of sludge and varnish deposit formation.

### Fuel Economy Benefit in Gasoline Compositions

Four different vehicles (2009 Chevrolet Malibu (2.4 litre), 2010 Mazda 3 (2.0 litre), 2008 Chrysler Town and Country (3.3 litre) and 2009 Dodge Challenger (3.5 litre)) were used for the evaluation of the difference in fuel economy between a base fuel and a test fuel.

The base fuel was an ethanol-free premium unleaded gasoline having a Road Octane Number of 91, specific gravity at 15.56° C. of 0.7186, and having 85.26% m/m of carbon and 14.74% m/m of hydrogen. The test fuel used was prepared by blending 400 ppmw of CH-6, based on the overall weight of the final composition, with the base gasoline.

The vehicles were tested on a chassis dynamometer using standard practice. The lubricant was changed at the beginning of each test. At least 3 standard US EPA HWFET (highway fuel economy test) cycles (Duration: 765 seconds, Total distance: 10.26 miles (16.5 km), Average Speed: 48.3 mph (77.7 km/h)) were run for both the base fuel and the test fuel.

The combined average fuel economy benefit or improvement of all four vehicles tested was 0.76% for the test fuel compared to the base fuel.

1. A method of improving the performance of the lubricant of an internal combustion engine, said method comprising fuelling an internal combustion engine containing the engine lubricant with a liquid fuel composition comprising:
(a) a base fuel suitable for use in an internal combustion engine; and
(b) one or more poly(hydroxycarboxylic acid) derivative having a terminal amine group having formula (III):
[Y—CO[O-A-CO]ₙ—Zₚ]ₘ—X (III)
wherein Y is hydrogen or optionally substituted hydrocarbyl group, A is a divalent optionally substituted hydrocarbyl group, n is from 1 to 100, m is 1 or 2, Z is an optionally substituted divalent bridging group, p is from 0 to 10, and X is terminal amine group or a group carrying a terminal amine group, wherein the terminal amine group is selected from —NR¹₂, wherein R¹ is independently selected from hydrogen and a C₁-C₆ hydrocarbyl group.

2. The method of claim 1 wherein the amount of the one or more poly(hydroxycarboxylic acid) derivative having a terminal amine group present in the liquid fuel composition is at least 1 ppmw, based on the overall weight of the liquid fuel composition.

3. The method of claim 2 wherein the amount of the one or more poly(hydroxycarboxylic acid) derivative having a terminal amine group present in the liquid fuel composition is in the range of from 10 ppmw to 20% wt, based on the overall weight of the liquid fuel composition.

4. The method of claim 1 wherein X is a group of the formula —Z¹-X¹, wherein Z¹ is a bifunctional linking compound and X¹ is a terminal amine group selected from —NR¹₂, wherein R¹ is selected from hydrogen and a C₁-C₆ hydrocarbyl group.

5. The method of claim 4 wherein Z¹ is a bifunctional linking compound selected from a polyamine, polyol, hydroxylamine, or a Z group.

6. The method of claim 1 wherein R¹ is independently selected from hydrogen and a C₁-C₄ alkyl group.

7. The method of claim 1 wherein X is a group of the formula —NH₂.

8. The method of claim 1 wherein the base fuel is a gasoline.

9. The method of claim 1 wherein the base fuel is a diesel fuel.

10. (canceled)

11. A lubricating composition comprising:
(a) a base oil; and
(b) one or more poly(hydroxycarboxylic acid) derivative having a terminal amine group having formula (III):
[Y—CO[O-A-CO]ₙ—Zₚ]ₘ—X (III)
wherein Y is hydrogen or optionally substituted hydrocarbyl group, A is a divalent optionally substituted hydrocarbyl group, n is from 1 to 100, m is 1 or 2, Z is an optionally substituted divalent bridging group, p is from 0 to 10, and X is terminal amine group or a group carrying a terminal amine group, wherein the terminal amine group is selected from —NR¹₂, wherein R¹ is independently selected from hydrogen and a C₁-C₆ hydrocarbyl group.

12. The lubricating composition of claim 11 wherein the amounts of the one or more poly (hydroxycarboxylic acid) derivative having a terminal amine group present in the lubricating composition is in the range of from 0.1 to 10.0 wt % based on the total event of the lubricating composition.

13. The lubricating composition of claim 12 wherein the amounts of the one or more poly (hydroxycarboxylic acid) derivative having a terminal amine group present in the lubricating composition is in the range of from 0.1 to 5.0 wt % based on the total event of the lubricating composition.

14. The lubricating composition of claim 11 wherein X is a group of the formula —Z¹-X¹, wherein Z¹ is a bifunctional linking compound and X¹ is a terminal amine group selected from —NR¹₂, wherein R¹ is selected from hydrogen and a C₁-C₆ hydrocarbyl group.

15. The lubricating composition of claim 14 wherein Z¹ is a bifunctional linking compound selected from a polyamine, polyol, hydroxylamine, or a Z group.

16. The lubricating composition of claim 11 wherein R¹ is independently selected from hydrogen and a C₁-C₄ alkyl group.

17. The lubricating composition of claim 11 wherein X is a group of the formula —NH₂.
